(19) United States
(12) Patent Application Publication
(10) Pub. No.: US 2003/0225663 A1
(43) Pub. Date: Dec. 4, 2003

(54) Open platform system and method

(76) Inventors: James P. Horan, Austin, TX (US); Wanda Kehlenbeck Tyner, Lee's Summit, MO (US)

Correspondence Address: BRINKS HOFER GILSON & LIONE, P.O. BOX 10395, CHICAGO, IL, 60611, US

(21) Appl. No.: 10/402,847

(22) Filed: Mar. 28, 2003

Related U.S. Application Data
(60) Provisional application No. 60/369,367, filed on Apr. 1, 2002.
(60) Provisional application No. 60/369,476, filed on Apr. 1, 2002.

(51) Int. Cl. G06F 17/60

(52) U.S. Cl. 705/36

(57) ABSTRACT

An open platform includes a portfolio management system, a workflow system, and a mutual fund recordkeeping system. The portfolio management system is configured to provide multi-asset transaction processing. The workflow system is configured to deliver and process work based on user-define priorities. The mutual fund recordkeeping system is configured to record a mutual fund transaction. The method of processing an open platform account includes receiving customer information; sending the customer information to a site for approval; checking that information to ensure the information satisfies a compliance criterion; and recording a mutual fund transaction in the mutual fund recordkeeping system.

### CROSS REFERENCE TO RELATED APPLICATIONS

This application claims benefit of priority under 35 U.S.C. §119(e) of (i) U.S. Provisional Application Ser. No. 60/369,367 filed Apr. 1, 2002, and entitled “Managed Account Platform System and Method” and (ii) U.S. Provisional Application Ser. No. 60/369,476 filed Apr. 1, 2002, and entitled “Managed Account Platform System and Method” which are each hereby incorporated by reference in their entireties.

The following co-pending and commonly assigned U.S. patent application has been filed on the same day as this application. This application relates to and further describes other aspects of the embodiments disclosed in this application and is incorporated by reference in its entirety.

U.S. patent application Ser. No. ______, “Managed Asset Platform System and Method,” Attorney Ref. No: 10098/314 filed on Mar. 28, 2003, and is now U.S. Pat. No. ______.

### FIELD OF THE INVENTION

This invention relates to asset management, and more particularly, to an open account platform system and method.

### BACKGROUND

As financial information grows and investment choices become more complex, many enterprises and investors are relying on personalized financial management. Personalized financial management allows enterprises and investors to retain more control over how their assets are invested, while relinquishing trading authority to advisors/managers and their firms.

One form of personalized financial management is called a managed account platform. A managed account platform services a professionally managed portfolio that holds assets of only one enterprise or investor. Like a mutual fund, a managed account can have a specific investing objective and an investment style. But unlike a mutual fund, an enterprise or investor can customize the portfolio and maintain direct ownership of those assets. The assets may include individual securities, such as stocks and bonds, mutual funds, futures, commodities, etc., or a combination of many assets.

Since managed accounts are fee-based investment accounts, wirehouses can provide regional and independent investment managers and other financial intermediaries with services and programs on a proprietary and/or non-proprietary basis. The ability to serve a large segment of these managers and intermediaries should reduce the costs of these services and programs to the investor.

While economies of scale are reasons to provide services to many users, there are many challenges to implementing a successful managed account platform. Since a managed account is customized, some systems have a closed architecture. These systems are not flexible and cannot interface external automated and/or manual systems. Disparate portfolio management and accounting systems, a variety of in-house trading and brokerage systems, and other existing applications, cannot be incorporated in some systems. These systems provide only core functionality and cannot support a host of third party systems, such as a mutual fund recordkeeping system.

### SUMMARY

The present invention is defined by the following claims. This description summarizes some aspects of the present embodiments and should not be used to limit the claims.

An open platform embodiment comprises a portfolio management system, a workflow system, and a mutual fund recordkeeping system. The portfolio management system is configured to provide multi-asset transaction processing. The workflow system is coupled to the portfolio management system and is configured to deliver and process work based on user-defined priorities. The mutual fund recordkeeping system is coupled to the portfolio management system and workflow system and is configured to record a mutual fund transaction.

A method of processing an open platform account embodiment comprises receiving customer information; automatically sending the customer information to a site for approval; automatically checking that information to ensure the information satisfies a compliance criterion; and recording securities and mutual fund transactions.

Further aspects and advantages of the invention are described below in conjunction with the present embodiments.

### BRIEF DESCRIPTION OF THE DRAWINGS

FIG. 1 is a functional diagram of a present managed asset platform embodiment.

FIG. 2 is a block diagram of the present managed asset platform embodiment of FIG. 1.

FIG. 3 is a system diagram of an alternative managed asset platform embodiment.

FIG. 4 is a system diagram of a compliance embodiment.

FIG. 5 is a system diagram of a performance measurement embodiment.

FIG. 6 is a system diagram of a trading embodiment.

FIG. 7 is a system diagram of a workflow embodiment.

FIG. 8 is a system diagram of a second alternative managed asset platform embodiment coupled to clients.

FIG. 9 is a functional diagram of an open platform embodiment.

FIG. 10 is a system diagram of the open platform embodiment of FIG. 9.

FIG. 11 is a block diagram of an open platform hierarchy.

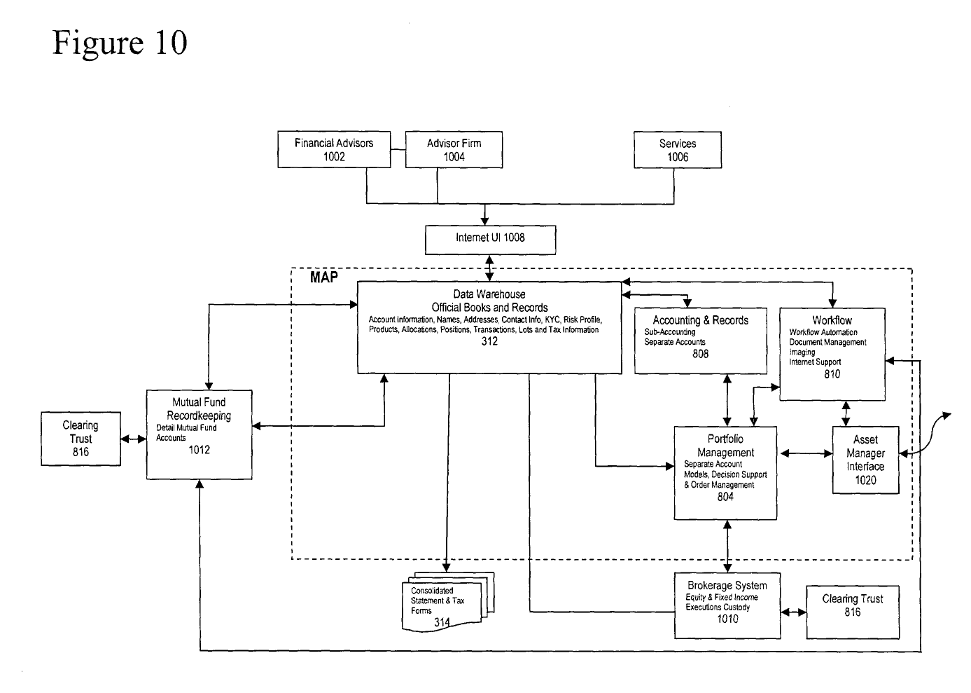

In the drawings, identical reference numbers identify identical or substantially similar elements or acts. To easily identify the discussion of any particular element or act, the most significant digit or digits in a reference number refer to the Figure number in which that element is first introduced (e.g., element 1012, the mutual fund recordkeeping system is first introduced and discussed with respect to FIG. 10).

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

### DETAILED DESCRIPTION OF THE PRESENT EMBODIMENTS

The present open platform embodiment provides access to customized portfolios. Preferably, the customized portfolios provide enterprises and investors with the ability to invest in many investment vehicles ranging from equities, fixed income securities, and mutual funds to other investment assets and combinations.

Preferably, the open platform embodiment is an integrated open product that provides functionality and processes to financial and investment advisor/firms (“advisors”), investment mangers/firms (“managers”), and their clients. Preferably, the embodiment aggregates data, provides full or limited trading functionality, provides reconciliation, reallocation, and rebalancing services for various investment products, and provides tax reporting and asset and account reporting.

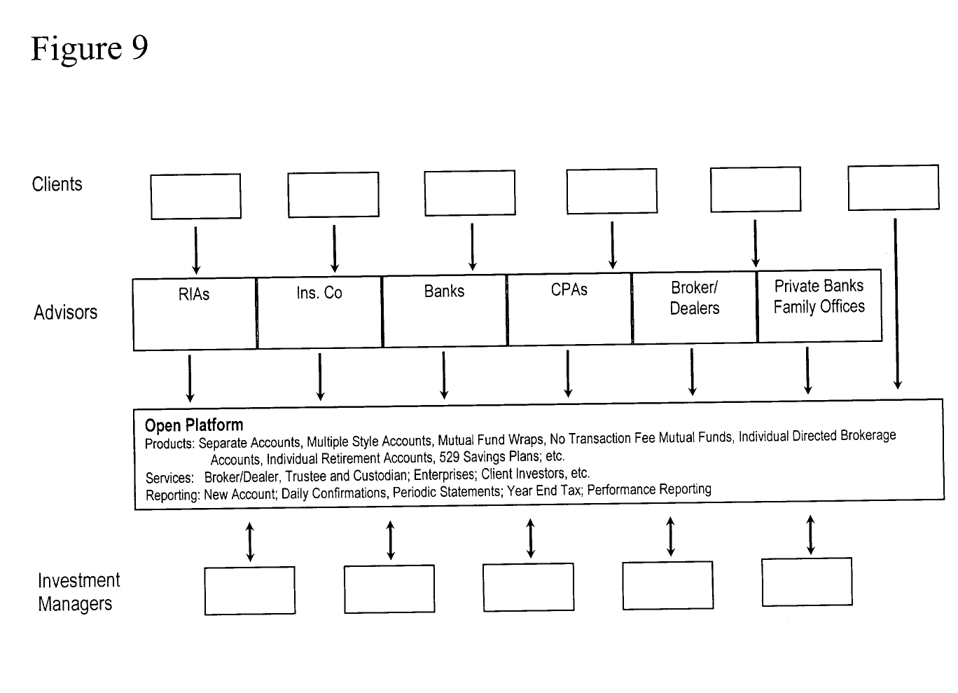

In the embodiment shown in FIG. 9, the present open platform supports separate accounts, multiple style accounts, mutual fund wraps, no transaction fee mutual funds, money market funds, individually directed brokerage accounts, individual retirement accounts (“IRA”s), and 529 accounts. Preferably, the separate accounts comprise equities, fixed income products, and other investments. These investments can be processed by decision support systems, order management systems, portfolio viewing systems, omnibus trading and individual trading systems, and compliance systems. Preferably, their performance can be measured against indices and benchmarks. Other open platform functionality provides ad hoc and/or scheduled rebalancing and reallocation of portfolio holdings.

Preferably, the multiple style accounts comprise predefined separate account styles managed by one or more investment managers. Like the separate accounts, these accounts can also be rebalanced and reallocated ad hoc or on a schedule.

Preferably, the mutual fund wraps comprise selected mutual fund combinations predefined by their percentage allocations. Some mutual funds wraps can have a total allocation to one investment and can comprise no transaction fee mutual funds. Preferably, mutual fund performance can be measured against indices and benchmarks.

Preferably, money market funds comprise a mutual fund investing in short term money market instruments, such as certificates of deposit, treasury bills, and commercial paper, for example. In the present embodiment, these funds can be used to channel investment flow to other funds and provide a source for investment and transaction fees.

Preferably, the individual brokerage accounts are directed by enterprises or investors. These accounts can support account inquiry, trade execution, trade confirmation, and/or tax reporting through an internal or a third party brokerage firm.

Preferably, the contributory and rollover individual retirement accounts (“IRA”s) comprise a long-term investment that can be established with a bank, credit union, brokerage house or other financial institution that permits tax-free accumulation of assets. In this embodiment, an individual retirement account can be invested in any of the above-described investment products.

Preferably, the 529 savings plan comprises a state or government sponsored investment program. In the present embodiment, this program is based on the tax advantages of Section 529 of the United States Internal Revenue Code (“IRC”).

As shown in FIG. 9, the open platform embodiment can support many forms of communication and information aggregation. Through reports, the open platform embodiment can provide new account welcome kits that explain financial investments and services, provide advisors with daily confirmations of investor and account data, and periodic statements of consolidated account activity. Some embodiments can also provide performance comparisons to benchmark indices, aggregation of industry sectors and year to date income receipts and realized gains and losses, year end tax packets and performance reporting to selected standards or predetermined or customized indices.

Using a publicly accessible user interface, such as the Internet user interface 1008 shown in FIG. 10, financial advisors 1002 and advisor firms 1004 can set up and maintain investment product selection, transaction and statement reporting, and view customer data, tax information, and other investment selections and performance in real-time or delayed time. Preferably, the web-based system allows advisors to establish accounts, products and product styles, investment allocations, initiate transactions and mailings and allow advisors to group client accounts.

In the illustrated embodiment, the Internet user interface 1008 provides access to on-line applications, forms, regulatory material, and search engines that allow advisors to inquire about investment positions, investment activity, tax lots and performance. It also allows financial advisors to view orders, execute trades through a third party brokerage system 1010, establish new accounts, review prospectuses, and view customer holdings across assets and funds.

Preferably, asset managers can access the front, middle, and back-office of a managed asset platform (“MAP”) through an asset manger interface 1020. Preferably, the asset manger interface 1020 enables asset managers to communicate with the managed asset platform. Such interfaces can comprise a command-line interface, menu-driven, or a graphical user interface, for example.

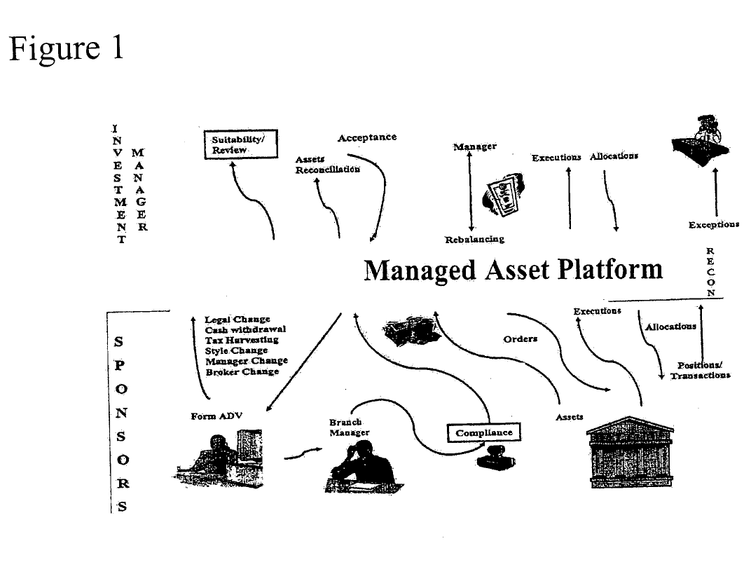

In the embodiment shown in FIG. 10, the managed asset platform embodiment allows investments to be managed at an individual or group asset level through workflow and portfolio management systems. It further provides advisors and asset managers access to third party brokerage systems 1010. Other features of the present managed asset platform are described below through FIGS. 1-8.

As shown in FIG. 10, the managed asset platform directly interfaces a mutual fund recordkeeping system 1012. This direct interface eliminates potential reconciliation errors that can occur when other system maintain participant recordkeeping and mutual fund shareowner accounting.

Preferably, the mutual fund recordkeeping system 1012 performs shareowner related functions for mutual funds, including, for example, processing purchases, redemptions, exchanges and transfers of shares; maintaining shareowner identification and share ownership records; reconciling cash and share activity; calculating and disbursing commissions to broker-dealers and other distributors; processing dividends; creating and tabulating proxies; reporting sales; and providing information for printing of shareowner transaction and statement data and year-end tax statements.

In the illustrated embodiment, the mutual fund recordkeeping system 1012 processes load, no-load, multi-class, and money funds. Some embodiments also perform many specialized tasks, such as asset allocation, wrap fee calculations, and broker commissions. Preferably, shareowner services 1006, such a mutual fund shareowner services, can be offered on a wide range of levels. A full range of services can provide administrative and clerical support to process and maintain shareowner records, answer telephone inquiries from shareowners, broker-dealers and others, and handle the mutual fund functions described above. In other embodiments, a limited range of services can allow clients to provide their own administrative and clerical staff services.

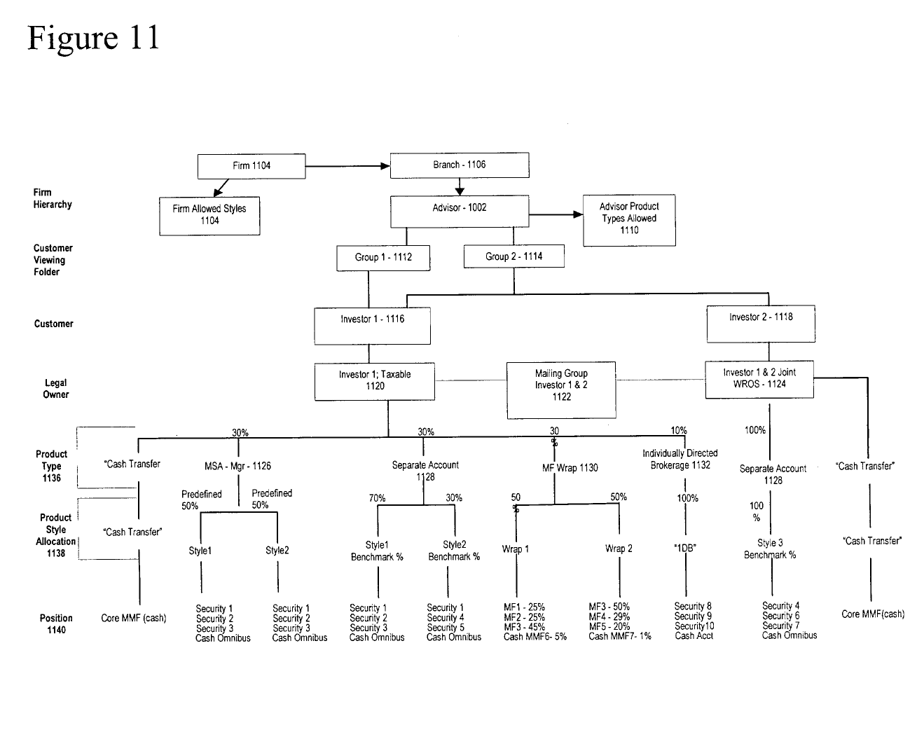

As shown in FIG. 11, the open platform embodiment can support firm and customer hierarchy and householding services. Preferably, a first-tier comprises an advisor 1002 that can belong to a branch 1106 and an investment firm 1004. Preferably, the investment firm 1104 defines the underlying markets to be traded and styles 1104 and allocates these products 1110 to the advisor 1002.

The customer viewing folder or second tier allows the advisor 1002 to view account groups. Preferably, the advisor 1002 can set up individual or group accounts. The group accounts can include a single investor and/or enterprise, or multiple investors and/or multiple enterprises. As shown, the first group 1112 comprises a single investor 1116 and the second group 1114 comprises multiple investors 1116 and 1118.

Preferably, the third and fourth tiers identify the customer, legal owner, and householding. In FIG. 11, the first investor 1116 owns a group of taxable products and the second investor 118 owns non-taxable products. The non-taxable products are jointly owned with the first investor 1116 who holds a right of survivorship to the second inventor 1118.

Preferably, a householding service 1122 can customize account communication to an investor's design. In FIG. 11, the householding service 1122 combines the account communication from the first and second investor 1116 and 1118 into one mailing. This consolidation allows the investors 1116 and 1118 to track materials more easily and track financial records more concisely. This service can also reduce electronic and postal mailing costs.

Preferably, investors can also select from multiple products. In the illustrated embodiment, the first investor 1116 has invested thirty percent of the investor's total portfolio into a multiple style account managed by one or more investment managers 1126. Although the investment manager(s) 1126 can allocate funds to any number of styles 1104, in this embodiment, the funds are allocated across two styles comprised of a composite of securities and money funds.

Through separate accounts 1128, the advisor 1102 can make investment selections to an appropriate sleeve. In this embodiment, twenty one percent (30%×70%) of the first investor's 1116 portfolio is invested a first style and nine percent (30%×30%) of the investor's portfolio is invested in a second sleeve. Preferably, each sleeve or style can be tested against a benchmark.

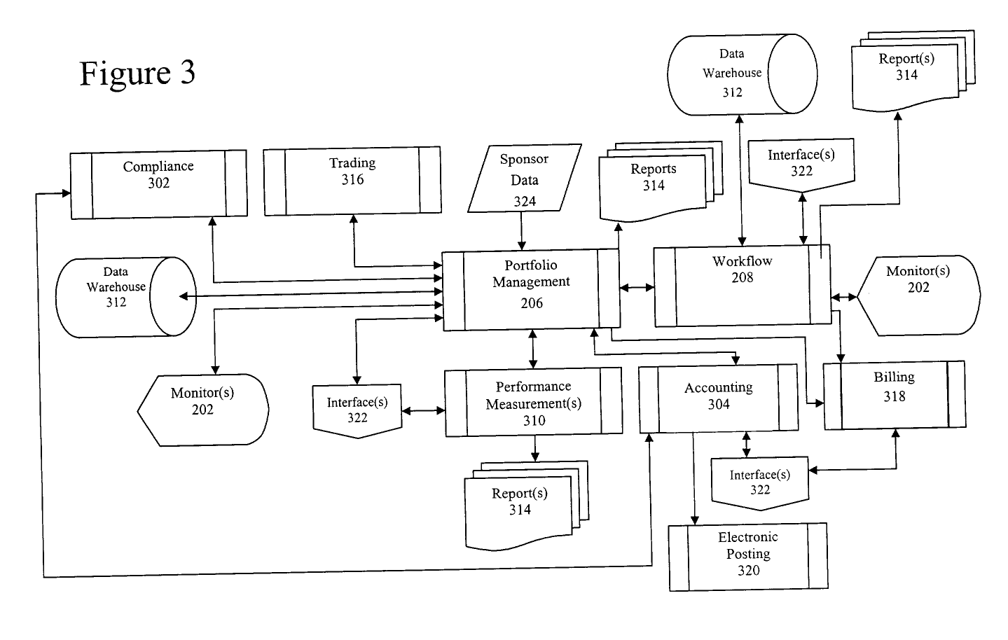

The present open platform embodiment allows rules to be created that perform an assessment or a comparison against benchmark data. Preferably, the benchmark data is predefined within the embodiment or defined by the advisor 1002 or an asset manager. Weekly, daily, monthly or real-time benchmark data can be stored in the data warehouse 312 shown in FIG. 3 and recalled for later use.

The open platform embodiment allows the advisor or asset manager to build absolute and variable rules that compare investment attributes such as technology and exposure of an account or a composite to that of a benchmark account and to build rules that compare portfolio data such as duration of an account or composite to that of a benchmark account. Preferably, the rules perform calculations on both an account and a composite. In some embodiments the rules can be used to rebalance or reallocate a portfolio automatically to a schedule or upon request.

In the illustrated embodiment of FIG. 11, the open platform allows the user to specify the use of benchmarks at the rule level. The reporting system 314 shown in FIG. 3 of the open platform embodiment can show the results of the comparison or assessment. Preferably, open platform embodiment permits advisors 1002 and asset managers to generate reports of the financial investments in the investor's portfolio as well as the characteristics of those investments.

In the mutual fund wrap 1130, preferably the advisor 1002 selects a mutual fund combination predefined within the open platform embodiment or the advisor 1002 can create the allocation. As shown, the first and second wraps comprise a composite of three mutual funds and a cash account. Like each of the illustrated embodiments, cash can be allocated by product type 1136, product style 1138, or position 1140.

Preferably, an individually directed brokerage account 1132 is set up on behalf of the investor at one or more brokerage firms. As shown in FIG. 11, the individually directed brokerage account 1132 allows the first investor 116 to buy and sell securities directly within the first investor's brokerage account through an internal or the third party brokerage system shown in FIG. 10. As shown, the first investor has invested in multiple securities and a cash account.

FIG. 1 is a functional diagram of a present managed asset platform embodiment that interfaces the mutual fund recordkeeping system 1012 and the user interface 1008 shown in FIG. 10. The present managed asset platform embodiment combines portfolio management and services with automated workflow systems. These services and systems are provided to investment managers, financial intermediaries, and distributors, brokers, and/or dealers (a/k/a sponsors), that select assets and styles based on their customer's objectives. Preferably, the present managed asset platform embodiment allows remote users to view and query their accounts by account number, client name, inception date, portfolio value, and asset allocation.

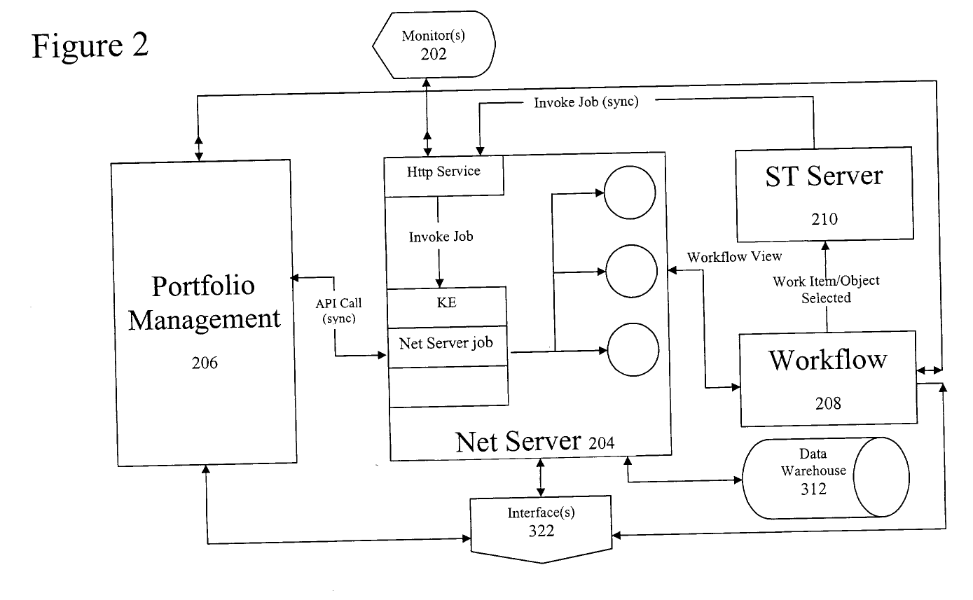

Functionally, the present managed asset platform provides scaleable trading and decision support tools. The present managed asset platform embodiment provides systems for initial and ongoing data mapping. In one embodiment, the managed asset platform receives data through a graphical user interface and/or a voice recognition system shown as remote and local monitor(s) 202 in FIGS. 2-7, and synchronizes sponsor data to internal data through a file transfer method, such as an end-of-day file transfer method. A present monitor 202 includes a graphical and a point & click interface. When interactive transfers are needed, the present embodiment can use a Java Bean based interface.

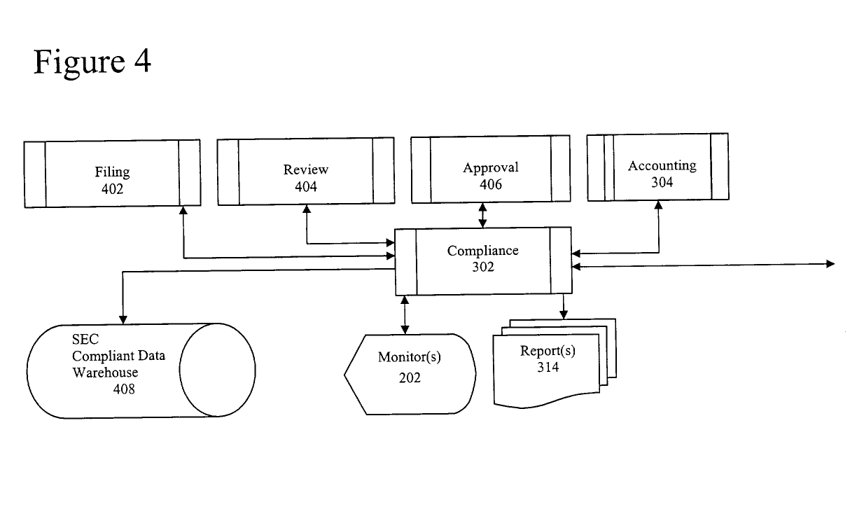

Preferably, the present managed asset platform embodiment allows sponsors to select many objects. Sponsors may initiate legal changes, cash withdrawals, tax harvesting, style changes, and manager and broker changes, for example. Through the graphical user interface or voice recognition system, a sponsor or broker can select one or a combination of objects from the portfolio management system 206. Once selected, an object can be electronically or manually reviewed by a manager and checked for compliance. Although the compliance function is illustrated as a manual or semi-automated system in FIG. 1, in alternative embodiments, compliance can comprise an electronic or automated system and/or method 302 that convert the filing 402, review 404, and approval 406 of a selected object through an entirely automated system as shown in FIG. 4. Preferably, a review 404 comprises a comparison of an object to a compliance criteria derived from a condition, a rule, a restriction, and/or a regulation derived from a client's investment guidelines and/or designated by a sponsor, an investment/branch manager, and/or a regulatory agency. A securities and exchange regulation, for example, can be a designated regulation.

One such regulation can be a restriction on wash sale trading. A wash sale is a sale of one security at a loss or gain to offset the loss or gain incurred on the sale of another security. A wash sale is accompanied by the purchase of identical securities within a sixty day period comprising thirty days before or after the sale. In the present managed asset platform embodiment, the wash sale restriction can be programmed as an account level restriction. Such orders can be blocked at the account level.

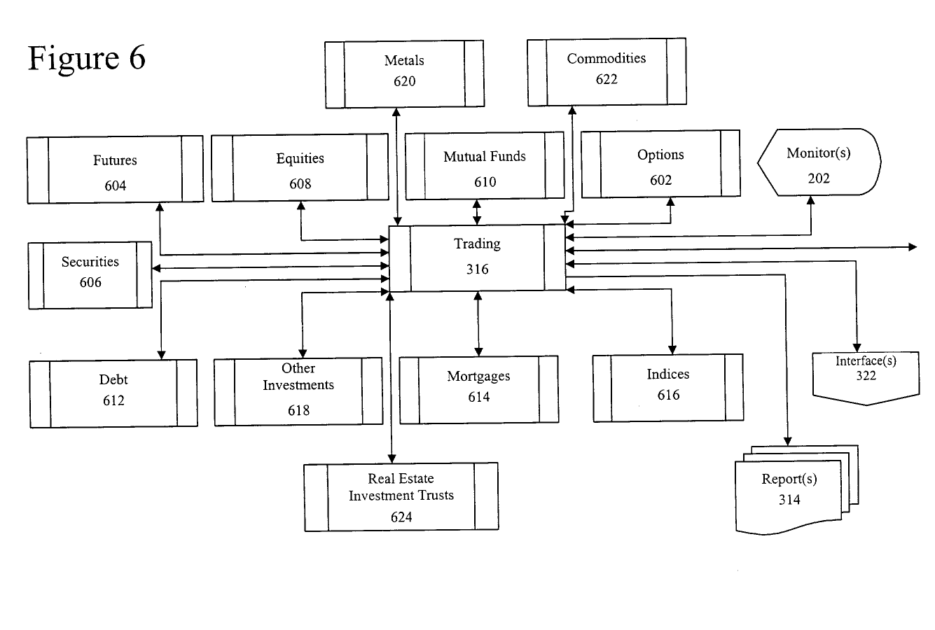

As shown in FIGS. 1 and 3, preferably, the present managed asset platform embodiment provides the investment manager with a data and/or analysis tools. When an object is selected, the present managed asset platform processes the object and executes or initiates an action. If an order is to be executed, for example, the present managed asset platform submits the order to a trader, a trading floor, and/or an automated exchange 316 as shown in FIGS. 3 and 6. Preferably, a user can buy or sell one or more options 602, futures 604, securities 606, equities 608, mutual funds 610, debt 612, mortgage backed securities 614, indices 616, metals 620 (e.g., gold), commodities 622, real estate investment trusts (“REIT”) 624, and/or other investments 618 across one or more accounts up or down to a specific percentage, override that specific percentage or a targeted percentage(s), or sell down one or more options 602, futures 604, securities 606, equities 608, mutual funds 610, debt 612, mortgage backed securities 614, indices 616, metals 620 (e.g., gold), commodities 622, real estate investment trusts (“REIT”) 624, and/or other investments 618 and use the proceeds to buy other futures, securities, investments, etc.

Preferably, through a straight-through processing (“STP”) and/or a financial information exchange (“FIX”) based order execution routing, the investment manager is linked directly to the trader, the trading floor and/or to the automated trading exchange 316 with little or no human interaction. The present system and method allow error-free real-time or batch trading and execution. Preferably, trade execution flows directly to the sponsors and investment managers for seamless error-free processing.

Upon execution, the present embodiment reconciles the trade by executing bookkeeping functions through the accounting system 304 shown in FIG. 3. Preferably, the accounting system 304 provides a real-time or delayed time portfolio accounting engine that is capable of delivering complete multi-currency (base, local income, and instrument), multi-asset class, transaction processing, and accounting including tax-lot accounting, as-of processing, comprehensive reporting, and easy integration with other investment applications. If additional efficiencies are desired, the present managed asset platform can split asset files into multiple data sets for parallel or serial processing. The present bookkeeping functions include tracking cash, daily positions, and identifying exceptions on wraps and/or on individual accounts.

Preferably, on a schedule, or upon a programmed time such as the close of the trading day, the present managed asset platform performs multiple functions. Those functions can include the recording of closing market data (prices), the loading of closing prices, the calculation of closing market values, the calculation and posting of corporate action entitlements for a new business day, and the synchronization of positions through transaction comparisons and the overlaying of cash balances based upon the daily transaction files or data received from a sponsor.

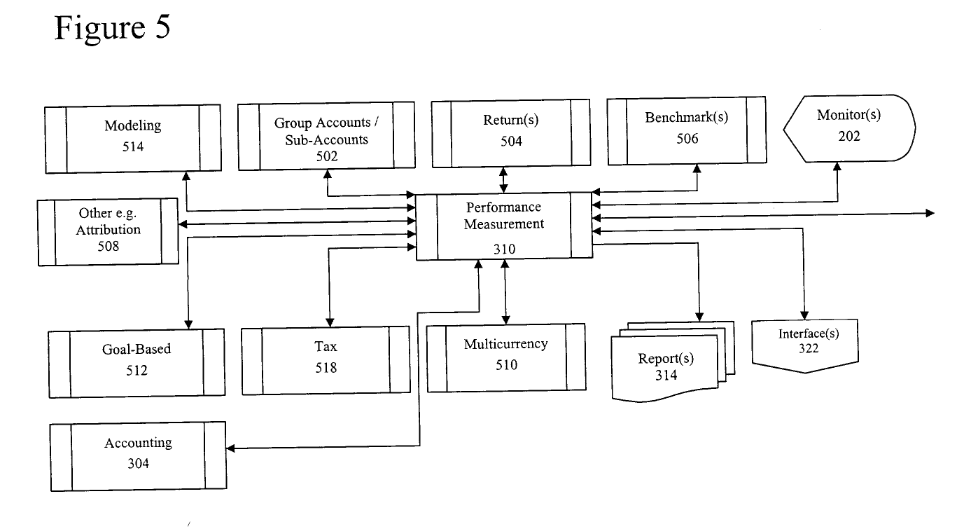

The present managed asset platform can also calculate the performance measurement returns 504 shown in FIG. 5 based upon the daily transaction files or data 324 received from a sponsor, calculate market values, schedule rebalancing of portfolios to selected financial models based upon the calculation of market values, and the synchronization of positions. When rebalancing, a present embodiment provides a user with a choice of rebalancing against a benchmark, another portfolio (an actual investor's portfolio or a model portfolio, for example), or a composite of multiple portfolios. One portfolio-rebalancing method uses percentage based targets or dynamic unit based model portfolios.

FIG. 2 is a system diagram of the present managed asset platform. Preferably, the managed asset platform can be accessed from a variety of connectivity methods, such as the Internet, a local area network, a wide area network, an intranet, etc, and can provide predefined sets of file transfer protocols (“FTP”) to pass files into and out of the system. Preferably, investment managers and broker/dealer and back office personnel access the portfolio management and workflow systems 206 and 208 through a Windows-based client or browser based thin-client technology. The present browser-based thin-client technology does not require the installation of product updates and service releases on a user's desktop because the present thin-client technology connects to the remote server(s) and runs all applications from a single or coordinated point.

The present managed asset platform embodiment is comprised of a portfolio management system 206, a workflow system 208, an ST server 210, and a Net server 204. The portfolio management system 206 includes tools used in a front office, middle office, and/or back office. These tools can track positions, perform analytics, provide decision support, manage orders, perform accounting functions, provide gain/loss trade modeling, perform compliance and/or, perform other portfolio measurements. One performance measurement system 310 shown in FIGS. 3 and 5 can use a modified Dietz method to calculate time-weighted total returns for accounts and composites.

As shown in FIG. 5, the present performance measurement system 310 can also group unrelated and related accounts or sub-accounts 502 to create composite accounts. Using composites, a user can measure performance using all of the functionality described herein. In the present embodiment, the composite account can be established by assigning a composite name and member accounts for a composite database, such as an account group database resident to the data warehouse 312 shown in FIG. 3, for example. A composite account can also be defined through a system account master table stored in the data warehouse 312. Preferably, the data warehouse 312 identifies where the present open platform stores data. The data warehouse 312 can include an operational data store that stores transaction processing related data and a relational data mart that can replicate all or some of the data store into a simpler data structure that can be used for generating reports. The data warehouse 312, that preferably can access all of a user's, an organization's, enterprises, or a company's information in some embodiments, provides the capabilities to consolidate data from multiple fund management systems, and maximize the accessibility and availability of data.

Preferably, the present performance measurement system 310 can also derive the principal return from a total return result. In addition, interest rate risk (“IRR”) and asset weighted returns can also be calculated and displayed. The present performance measurement system 310 accepts accounting transactions, flows, market values, accrued income, and earned income to calculate performance returns 504, and in some alternative embodiments, report separate account performances, such as a Net Asset Value (“NAV”), which is a cumulative market value of the assets net its liabilities.

Preferably, the performance measurement system 310 provides the user with the flexibility to measure performance returns 504 on any user-defined investment scheme or classification. In one embodiment, the performance calculation method can calculate total returns for daily, monthly, or any user defined performance period. With performance returns 504 obtained by de-linking daily or monthly unit values for the desired time periods, other performance time periods can also be specified, such as quarterly, semi-annually, annually, and from an inception date.

Preferably, benchmarks 506 can also be created from either market indices or by creating blends of several markets or user definable indices of any currency required to facilitate a desired comparative analysis. Dynamic or static weighting can be applied to each index in some embodiments, where static weightings are applied these can drift with the underlying performance of each index. In the present embodiment, benchmarks 506 can be used to analyze the effectiveness of the investment decisions through a supporting analysis from a comparison of a portfolio and its benchmark to a more complex attribution and risk analysis. Since benchmarks 506 can also be represented as passive portfolios in the present embodiment, the performance measurement system 310 supports complete flexibility in determining what portfolio is analyzed with respect to a target portfolio. Preferably, both internally and externally generated benchmark returns are stored in the data warehouse 312 that also stores account data. Preferably, the data warehouse 312 is resident to, or is coupled to, the net server 204 shown in FIG. 2.

A return based attribution analysis 508 shown in FIG. 5 can also be executed through the present managed asset platform to facilitate the analysis of portfolio returns on an absolute basis or relative to predetermined benchmarks. For equities, returns may be attributed to investment selection, allocation, and currency components. For fixed income assets, returns may also be attributed to duration bands. Similarly, a security-based attribution analysis can be performed down to an individual security level. Both a domestic and global attribution method can be used to attribute allocation and investment selection effects independently, for currency and market returns. In addition, the performance measurement system 310 can be customized to measure style-based performance.

In some embodiments, the performance measurement system 310 also provides multi-currency performance capabilities 510 through a multi-currency performance measurement and attribution system. Preferably, attribution can be performed in a single or multi-currency scenario. For single currency attribution calculations, for example, the Brinson Additive, top-down multiplicative, and bottom-up multiplicative methodologies can be used. Multi-currency attribution calculations can use absolute global attribution multiplicative, relative global attribution multiplicative, Karnosky Singer attribution, and enhanced Karnosky/Singer Additive methods.

In some embodiments, the performance measurement system 310 has a goal-based performance measurement capability 512 as further shown in FIG. 5. Preferably, the performance measurement system 310 calculates a daily or monthly valuation of a portfolio for any user-defined historical period. A portfolio modeling application 514, for example, can also provide goal-based functionality to calculate how much of the selected instrument should be traded to bring an investment node in line with its benchmark. In some embodiments, there are also specialized or generic interfaces 322 that facilitate integration of third-party simulation applications and other functionality to the present managed asset platform. The present managed asset platform, and more specifically, the performance measurement system's 310 architecture can be integrated with many third party investment systems.

Preferably, the performance measurement system 310 supports criteria for capital gains and losses specified by all, or from selected tax acts and/or rules 518, such as the Tax Relief Act of 1997. For sales after July 1997, for example, the present system and method calculate after-tax performance and measurement inclusive of three possible holding periods: Short Term (less than or equal to 12 months); Mid Term (greater than or equal to 12 months plus 1 day, but less than or equal to 18 months); and Long Term periods (greater than or equal to 18 months plus 1 day). In alternative embodiments, the tax system 518 allows for tax-lot trading and other tax managed trading and tax optimization tools. In an embodiment that allows for tax-lot trading, records of transactions and their tax implications involving a particular security or another asset are tracked in a portfolio within the data warehouse 312. These records document the taxable purchase dates and provide the holder or an intermediary with the option of specifying exactly which shares to sell at a later date in order to reap tax advantages.

The performance measurement system 310 is preferably scalable and preferably resides on one or more servers. In this present embodiment, the portfolio management servers are high-end Sun Solaris boxes (ES4500s), hosting Sybase data stores. Preferably, the communication gateways are hosted on Windows 2000-based server class machines. These present machines use a DB2 database for holding pricing and security related masters and preferably can interface third party systems, such as brokerage and/or billing systems. Some performance measurement functionality resides in a relational data model within a UNIX environment. Preferably, backup servers with appropriate configurations provide system redundancy.

Preferably, the present portfolio management system 206 interfaces the workflow system 208 through a present net server 204 and an ST server 210 as shown in FIG. 2. Preferably, the present net server 204 allows investment managers and/or sponsors to access portfolio management and workflow functionality through a variety of platforms and connectivity methods. The portfolio management's Common Object Request Broker Architecture layer (“COBRA”) enables the present net server 204 to receive data from any application running an object receiver broker. The present object oriented design, preferably allows portions of the present net server 204 to be re-architected without affecting the functionality of the present portfolio management and workflow systems 206 and 208.

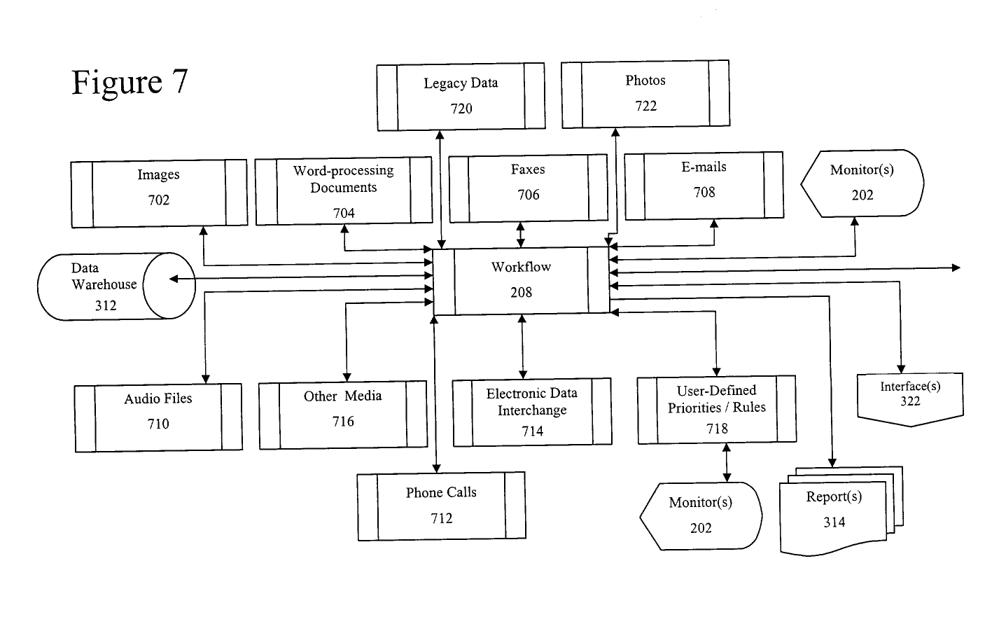

Similarly, the workflow server provides process management functionality that is capable of creating or capturing workflow objects. These workflow objects can be created or captured from multiple sources as shown in FIG. 7. Such sources can include images 702, word processing documents 704 (e.g., Object Linking and Embedding documents, “OLE” documents), faxes 706, e-mails 708, audio files 710, phone calls 712, Electronic Data Interchanges (“EDI”s) documents 714, legacy system data 720, digital photos 722, other media 716, or any combination of inputs that generate information. Preferably, the workflow system 208 delivers work flow objects based on user-defined priorities and/or business rules 718. The present priorities 718 can be based on specific information and/or age and status of the work. Preferably, a table-driven architecture supports the workflow process by archiving, retrieving, and delivering and/or displaying information to the appropriate person or automated system. Preferably, the workflow can be customized by user-selected priorities that assure that the most important work is processed.

In one embodiment, workflow provides a system and method that automatically guides the user through the acts and/or business rules necessary to process an item of work. Preferably, task management is also seamlessly integrated into a user's desktop. The present task management enables a series of tasks that can change dynamically based on the results of previous task acts.

The present workflow system 208 also provides advanced customer relationship management capabilities. The present capabilities allow financial advisors, broker/dealers, and investment managers to manage workflows more efficiently and with improved quality. In addition, the integration of work automation greatly reduces lead times by automating and enhancing processes such as new account creation, application approvals, authorization, and document management. When opening a new account, for example, the present managed asset platform automatically opens a form that receives data and automatically populates selected account fields and adds information to selected fields as it is received. In some present embodiments, the account can be reviewed by the branch manager in real-time or in delayed-time.

In some present embodiments, the workflow system 208 provides rendezvous processing that automatically or semi-automatically links at least some common information that is received from common or different sources. Preferably, the workflow system 208 provides push-and-pull work selections. In a workflow-push selection, a workflow server loads data to the client, but the workflow server client data connection stays open. This continuous connection allows the workflow server to continue sending data to the client as necessary. In a client pull selection, the workflow server loads data to the client, but the data connection does not stay open. In some embodiments the workflow system 208 has an interoperability with other workflow systems via the interface 322 and/or utilizes parallel processing. The present workflow server runs on a high-end AS/400 Server, running OS/400 DB while the workflow fax is run off server-class NT machines.

One performance measurement system 310 is a transaction based, multi-asset class, multi-currency performance measurement and attribution solution that allows the investment manager to conform to performance presentation standards established by the Association for Investment Management and Research (“AIMR-PPS”) and the Global Investment Performance Standards (“GIPS”). This performance measurement system 310 is a scaleable solution utilizing a relational data model linked to the data warehouse 312. In the present embodiment, the performance measurement architecture can be integrated with many third party investment systems. The present data warehouse 312 has the capability to consolidate data from multiple fund management systems, and maximize the accessibility and availability of data. Other performance measurement functionality includes security level detail, extensive risk and dispersion analytics, and client defined performance modeling.

The present reporting system 314 embodiment shown in FIGS. 3-6 is a Web enabled reporting tool that facilitates the aggregation of data from multiple sources for user-defined batch production and ad-hoc hard copy reports as well as the delivery of such reports over a publicly accessible (e.g., Internet) and/or a privately accessible networks. Pictures, text, charts, logos and diagrams can be included in the reports. In addition to providing pre-defined report templates that can be used to describe single, composite, and group accounts, reports can be generated on an ad-hoc basis. The present embodiment also allows users to generate aggregate account reports using flexible grouping parameters, such as a groupings by broker or by money managers.

To generate one type of customized report, a user selects the Account Type option (Single, Composite, Group) to elect the account(s) to be included through the portfolio management system 206. The user then defines the type of report to generate. In some embodiments, the managed asset platform may require a selection of an investment scheme. After a defined report is created, the user defines a date range and elects to view or print the report. Preferably, the reports can be distributed in an electronic format such as in a portable document format (“PDF”), comma-delimited, text, a hypertext markup language (HTML), and/or a dynamic hypertext markup language (“DHTML”) for viewing by commonly used Web browsers. Also, report data can be exported to a spreadsheet such as Microsoft Excel for further manipulation or replicated on a remote or a client site allowing the client to report out of their own copy or publish the reports via the Web. Preferably, quarter-end performance reports are available at the end of trading day, when scheduled, overnight, or when the off-peak processing is completed. Furthermore, month end returns are not geometrically linked from daily or sub-period records in some embodiments. The month-end returns are geometrically de-linked from unit values, thus saving processing time when calculating the month end linked return. If an auditing of data is required, such reports can be available later in time.

Preferably, the reporting system 314 provides users with the capability to generate any user-defined report in real-time or on a batch basis. Any user-defined report can be generated. Presentation quality reports, for example, can be produced from a variety of data sources containing form and content which can be both dynamically driven from data and configurable by the end user. Moreover, because all updates to system reference data are captured in an audit database within the data warehouse 312 in some embodiments, the data may be queried to list any activity such as showing new accounts, closed accounts, and any capital adjustments that occurred on a specified day. In the present embodiment, transaction activity is indexed by several dates including entry date, post date, effective date, trade and settle dates. Thus, transaction activity may be queried by date and type of activity as well. The present reporting system 314 can include an open relational data model for reporting purposes.

The optional trading system 316 shown in FIGS. 3 and 6 can comprise a suite of decision support and trade order management tools providing a complete workflow model from order generation to execution. The present functionality includes an order blotter for constructing workbooks for individual managers and dealers; order bulking for aggregating orders across styles for best execution practices; order placement for automated and/or step-out placements for best execution practices; and order execution for automated orders.

The present trading system shown in FIG. 6 provides trade related downloads to allow for user customization, such as in a Microsoft® Excel format. Preferably, the trading system 316 also allows for fixed income securities 606 to be traded at face value, with duration, yield, rating, and exposure trading parameters available for all fixed income securities. In the present embodiment, the trading system 316 also allows for account level security restrictions to be imposed on the buy and/or sell side (e.g., an insufficiency of cash), securities to be swapped within a particular industry (e.g., IBM for Hewlett Packard, for example), and allow orders to be based on an-account level percentage allocations through the portfolio management system 206. At a user's election, trading percentages can be expressed as a percentage of a total portfolio or by sector only.

In some embodiments, the managed asset platform includes an optional billing system 318 shown in FIG. 3, or utilizes a third party's billing software. The present billing system 318 can debit investment management and transaction fees directly from a client's account and tailor and/or apply fee schedules to enhance flexibility.

The present managed asset platform is a scaleable system and method from a workflow and a portfolio management perspective. The present system and method lends itself to a variety of configurations that can be enhanced, changed, or isolated to a server or a server cluster based on system load and volume throughput. From a workflow perspective, the present embodiment can activate a team processing such that if the volume of work gets very large, categorized work (by range or account numbers, for instance) can be isolated to be routed to predefined entities or servers. From a portfolio management perspective, the system scales well to make use of multiprocessing and system threading. Data replication can be used for load sharing and distribution.

One enhancement of the present embodiment integrates a regulatory compliant management system designed to collect, confirm, and maintain formal consent from investors for each product in which they invest, a hypertext markup language (HTML) SEC-compliant data warehouse 408 shown in FIG. 4 that provides electronic access to a library of prospectuses, and a regulated communication system that can include trade confirmations, and/or account statements, and/or check images, and/or tax forms to the present managed asset platform.

Another enhancement to the managed asset platform integrates the Informa^{SM} Suite of products available from DST Systems, Inc. to the present managed asset platform. The Informa^{SM} Suite provides electronic posting 320 of client confidential information and statements over a secure email system and/or publicly accessible network. The present suite uses a unique control number or another identifier linked to an investor's registration and ownership information. To view confidential electronic information and statements, an investor's control number or identifier is authenticated against the records retained in a database. Preferably, the database is retained within the data warehouse 312.

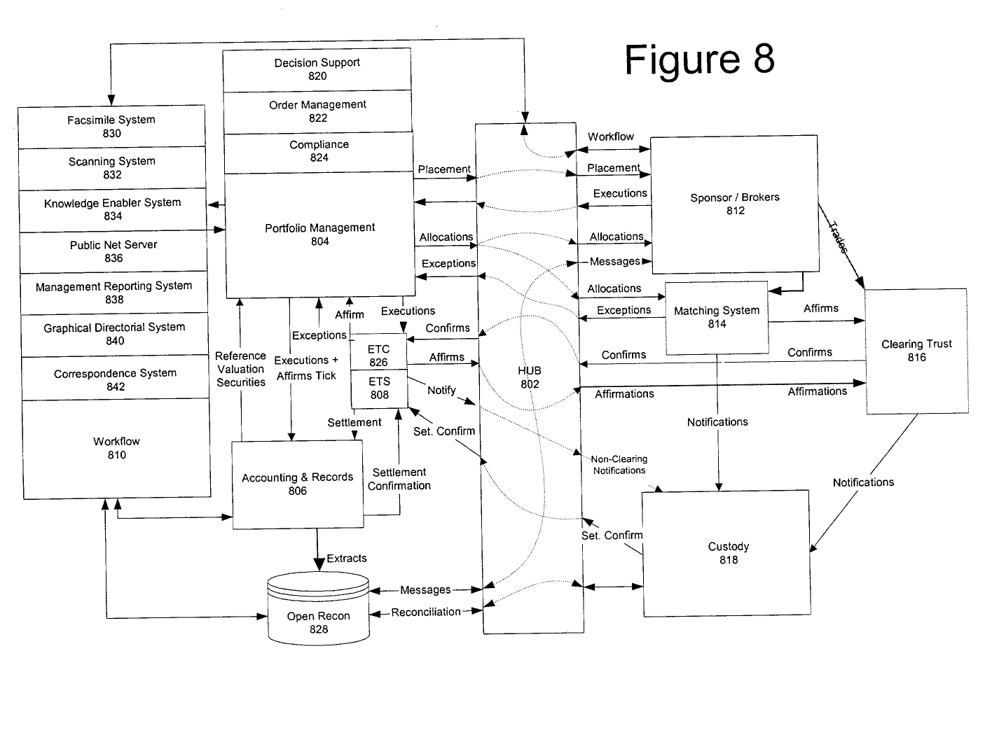

FIG. 8 is a system diagram of an alternative managed asset platform embodiment coupled to clients. This managed asset platform illustrates a hub-and-spoke relationship, wherein each resource, application, or order flows through a single entity (e.g., the hub 802) before being received by the interfaces and/or servers that serve the client. In this embodiment, the hub 802, the portfolio management system 804, the accounting and records system 806, the optional trade system 808 and 826, the open reconciliation system 828, and the workflow system 810 comprise the present account managed platform embodiment. The present account managed platform embodiment as well as the entire open platform embodiment can reside in a single server or a server cluster that comprise a group of independent computers that work together as a single system but present the appearance of a single server to one or more clients. In FIG. 8, the clients are illustrated as the sponsor/broker's systems 812, a matching system 814, a clearing trust system 816, which can comprise a clearing system or clearinghouse, and a custodial system 818. The clients couple the hub 802 through one or more networks such as a wide area network (“WAN”), a local area network (“LAN”), a ring network, a token ring network, a bus network, a publicly accessible network (e.g., such as the Internet), a privately accessible network (e.g., such as an intranet), etc.

Preferably, the hub 802 comprises a management server. Preferably, the management server electronically receives, converts, and transfers data into protocols used by the portfolio management server, the accounting and records server, the optional electronic trade server, and the workflow server. In this embodiment, the hub 802 can also provide routing control to the portfolio management server, the accounting and records server, the optional electronic trade server, and the workflow server. When orders are matched automatically or by physical trading, preferably the details of the trade and information of interest to the market are returned to the optional electronic trade server that directly interfaces the portfolio management server and indirectly interfaces a matching, a clearing, and a custodial system 814-818 through the hub 802.

Preferably, the portfolio management system 804 includes a suite of front office applications that can be used by an institutional fund manager. In the illustrated embodiment, the portfolio management system 804 includes a decision support system 820, an order management system 822, and a compliance system 824.

Preferably, the present decision support system 820 provides a single entry point of access to information about the assets under the present embodiment's management. The present decision support system 820 offers enhanced support through visualization and inquiry tools, portfolio modeling, and scenario analysis. The present decision support system 820 also allows for the checking of investment restrictions throughout the decision support process and the filtering of executions based on broker, instrument type, and transaction type.

The present order management system 822 manages an order management cycle from its placement up to and including its execution, not only for individual trades, but also for program and omnibus trades. The present order management system 822 can support multiple allocation routings and provide continuous measurements of execution quality using methodologies and benchmarks of a fund manager, sponsor, and dealer's choice through an order blotter. Preferably, the order blotter can track market impact, implementation shortfalls, profit and loss scenarios, and other measures for any selection of orders, markets, sides, industry, trader or broker, as well other parameters.

The present compliance system 824 provides checks and constraints on investment activity. In this embodiment, the checks and constraints can be programmed through rules and restrictions. A rule can apply for a defined or a programmed period of time. A restriction can be more dynamic. For example, a restriction can be applied when a particular situation arises and turned off when that situation passes. If, for example, a proposed trade is not compliant, as the orders that comprise the trade are processed, a compliance monitoring system compares the proposed trade to the programmed rules and restrictions. When the violation is detected, the processing of the orders is suspended and the user can be notified directly or through the workflow system 810.

If the orders are compliant, the proposed trade can be executed by a matching system 814 that interfaces the hub 802 or by the optional trading system 808 and 826, illustrated as an electronic trade confirmation system (“ETC”) 826 and an electronic trade system (“ETS”) 808 that directly interfaces the portfolio management system 804. These optional trading systems 808 and 826 can comprise an exchange where transactions occur through traders on a trading floor or through an automated matching system.

Upon execution of a trade, preferably the matching system 814 or electronic trade confirmation system 826 transmits the details of the trade to the portfolio management system 804 and the clearing trust 816. Preferably, the clearing trust 816 performs novations while the portfolio management system 804 routes individual, bulk, or multiple allocations to the sponsor/broker's internal accounts. Preferably, exceptions are routed to the portfolio management system 804 or the workflow system 810 that promptly alerts the sponsors/broker's systems 812 to the exceptions. In some embodiments, transactions summaries are also provided to the sponsor/broker systems 812 to assist in the reconciliation process.

Preferably, settlement instructions are sent to the accounting and records system 806 and notifications are sent to the custodial system 818 from the electronic trade system (“ETS”) 808 or the clearing trust 816. Once the notifications are received and are manually or automatically settled, the custodial system 818 sends a settlement confirmation that is used to update the accounting and records system 806. In the present embodiment, the accounting and record system 806 maintains the sponsor/broker's books including the general ledger, historical records, transaction processing related data, back-office data, performance tables, etc. As shown in FIG. 8, the accounting and record system 806 also receives investment value updates and provides valuations to the portfolio management system 804.

In the present embodiment, the accounting and records reside in a real-time financial transaction system that handles all security types. Preferably, the accounting and record system 806 provides sponsor/broker systems 812 with complete multi-currency position tracking and accounting applications. In the illustrated embodiment, all information related to a portfolio change or an investment event is captured in the accounting and record system 806. Preferably, a rule-based processing updates transactions, inventory, general ledger, performance tables, and other data in real-time. In some alternative embodiments, some or all of this information is updated by a batch process

Preferably, the accounting and record system 806 can provide accounting and query functionality. The present embodiment can track real-time inventory positions, multiple cost basis, tax-lot accounting, average cost accounting, multiple inventory relief methods, limited or unlimited historical position balances, income accruals, amortization/accretion, expense accruals, market valuations, multi-currency transaction values, and tax withholding and reclaim processing.

Through a multi-tier client/server technology and optimized relational architecture, the accounting and management system 806 can provide an accurate ledger-based multi-currency portfolio accounting for commonly traded securities traded in international markets. The present accounting and record system 806 can track momentary amounts in a base, local, income and settlement currency. Preferably, some embodiments can maintain security positions on an average cost or tax-lot basis that can be used to calculate realized gains and losses. Some accounting and records system embodiments 806 can also maintain multiple cost bases and/or maintain inventory positions for security and currency balances. Preferably, the income and accrual receipts for both fixed and variable rate securities are also tracked in some embodiments. Other embodiments can also track amortize market premiums of face value and accrete market discounts or original issue discounts to face value, support straight-line and scientific calculation methodologies, calculate market valuations in base and local currency for each outstanding net security position, track foreign tax withholding, foreign tax expense, and foreign tax reclaims associated with dividend and interest income, and/or etc.

To ensure that the accounts resident to the custodial system 818 are in compliance with the records resident to the accounting and records system 806, the present managed asset platform randomly or selectively reviews and evaluates custodial and customer accounts. Through an open reconciliation system 828, illustrated as “Open Recon” in FIG. 8, a present method extracts account related information from the accounting and records system 806 and compares that information to the information resident to custodial system 818. If a variance is found, preferably, the open reconciliation system alerts the sponsors/broker system 812 directly or through the workflow system 810 to resolve the variance. If an adjustment is needed, preferably, the sponsor/broker can make a manual adjustment. Alternatively, a proposed reconciliation can be suggested by a rule defined within the open reconciliation system 828 and/or accounting and records system 806. In this alternative embodiment, a proposed reconciliation can be suggested to the sponsor/brokers, and a reconciliation of some or all of the selected variances can be automatically or manually executed.

Preferably, an automated workflow system 810 includes components for workflow automation, document management, imaging, Internet support, and application system integration interfaces. Preferably, the workflow system 810 serves as a central repository for all types of inbound and outbound customer contacts, including postal mail, facsimiles, audio files, electronic data interchange (“EDI”) documents, electronic mail, and Web interfaces. As shown in FIG. 8, the present workflow system includes a facsimile system 830, a scanning system 832, a knowledge enabler system 834, a public net server 836, a management reporting system 838, a graphical directorial system 840, and correspondence system 842.

The present facsimile system 830 comprises a client server system that has in-bound and outbound faxing capabilities. The inbound faxes can be indexed and routed into a workflow process based on a sending phone number, a programmed identifier, or by the number dialed. In the present embodiment, multiple documents within a fax transmission can be distinguished with the insertion of blank pages between each document. Preferably, all requested transmissions are logged into the workflow server that interfaces the portfolio management server. Preferably, the logged information can identify a requester, a document, a time, and a receiver.

If facsimiles are not identified, preferably, the unidentified facsimiles are placed in a queue for a manual identification and a workflow routing. In the present embodiment, outbound faxes can be sent many different ways: any authorized user can access a desktop fax function through an external interface; the present facsimile system 830 can automatically send a fax when a work item reaches a pre-defined step in a workflow process; and an application program can generate and send a fax through a application program interface (“API”). Preferably, outbound faxes can be sent individually, in groups, or can be sent at a designated time. Faxes can be sent to one number or to a list of numbers. The present facsimile system supports multiple concurrent inbound and outbound fax transmissions.

The present scanning system 832 can perform the scan, capture, and archival functions of workflow. Preferably, the scanning system 832 comprises combination of scanning hardware and software that can move a light-sensitive device across an image-bearing surface, such as a page of text, converting the light and dark areas on the surface to a code that can be interpreted and manipulated by a computer.

Preferably, the scanning system embodiment 832 can enhance image quality. Once an image has been enhanced, the images can be staged for indexing into the workflow process. Preferably, the scanning system 832 also allows for control of sensitivity, threshold, contrast, resolution, and overall clarity of an image. To provide a maximum throughput of incoming documents, preferably sponsor/brokers 812 can operate multiple scanners in the same location as well as scanners in multiple remote locations simultaneously.

In some embodiments, the scanning system 832 can support document sizes through 11″×17″ inches; handle a variety of paper stocks, support Tagged Image File Formats (“TIFF”) and Mixed Object: Document Contents Architecture (“MO: DCA”) file formats; create documents in the standard group IV CCITT compression format and processes both single and dual-sided scanning. Some scanning system embodiments 832 support both batch and interactive scanning; perform image cropping with numeric values; tracks storage of source documents by assigning a box and page number to each document and provide uninterrupted scanning if the workflow server is unavailable. Other embodiments can also support multiple bar code types and a vertical or horizontal spraying of information onto selected location of a scanned document.

Once scanned, preferably an image object can be viewed through an object display window through the sponsor/broker's system 812 that interface the workflow system 810. Preferably, the interface provides common controls for the display and manipulation of the document image or a facsimile in a fixed or revisable format text. Preferably, the object window controls can be accessed from other interfaces, which reduce the need to constantly move between windows while processing a workflow object.

Preferably, the object window display can magnify scanned objects, rotate the scanned objects a fixed or variable amount with a click of a pointing device (e.g., a mouse), and scroll up, down, left, and right. Preferably, some object window displays can size an image to fit a window, invert image contrasts, such as black on white/white on black and insert horizontal and vertical lines. Preferably, some object windows can also cascade or tile pages, support multi document interfaces (“MDI”), allow a user to create image and/or textual annotation, allow overlays to be added to a source document and mask and/or highlight selected areas of a document

The present knowledge enabler system 834 is a business rules engine that guides a user or an automated process through a visual or programmed decision tree. Preferably, the decision tree is seamlessly integrated into the sponsor/brokers' desktop, taking control of workflow objects to be processed. Preferably, the knowledge enabler system 834 initiates a series of tasks, which can change dynamically based on the result of a preceding act. The present knowledge enabler system 834 can be invoked by the sponsor/brokers or automatically by pre-defined acts within a decision tree process. In the present embodiment, the decision tree comprises a task list that is performed on a workflow object.

The present public net server 836 comprises a workflow system that enables sponsor/broker's system 812 to comprise a thin-client, browser-based interfaces to manage workflow objects. Preferably, the public net server 836 can integrate workflow functionality into a privately accessible and a publicly accessible network.

The present management reporting system 836 provides real-time queries about work in process and a configurable set of historical reports on productivity and quality. Preferably, the management reporting system 838 interfaces or included a data warehouse having an online analytical processing database (“OLAP”) that can interface a sponsor/brokers graphical user interface (“GUI”) or desktop used to design and run queries. Preferably, the management reporting system 838 includes a built-in reporting system that allows sponsor/brokers to automatically track productivity and/or quality statistics. The present workflow reports can provide sponsor/brokers with up-to-minute information about volume, work-in-process, and productivity. Electronic feedback is also available in delayed or real-time, providing sponsor/brokers with up-to-date information regarding how much and what kind of work has been received, the status of the work within the pre-established workflow process, and who is available to execute the remaining tasks.

Preferably, the graphical directorial system 840 provides users the ability to define workflow acts in a visual format, making it easier to envision what should happen at each logical work act in the workflow process. Preferably, the visual work act allows the workflow to be administered in a series of pictorial icons. Arrows and connectors depict what happens to work objects at each step and the possible outcomes. Using the icons, sponsor/broker users can arrange a map of each work process. In the map, each work act, path between work acts, and begin and end work acts can be displayed on a screen and manipulated by the sponsor/broker's systems 812.

Through the present graphical directorial system 840, sponsor/broker users can make changes to the workflow in real-time or delayed in time. Preferably, a workflow includes all or some of the activities in a task or a project from start to finish. Sponsor/brokers can design the workflow acts without applying them to a processing database resident to or coupled to the workflow system 810. Once a series of changes has been completed, sponsor/broker users can apply all of the acts to the database in one action. When working offline, sponsor/broker users have the ability to work through the normal trading day to change a workflow process and then schedule the change for a time that does not disrupt the trading day.

Preferably, the graphical directorial system 840 has the ability to copy workflows. The present copy function is useful when a new workflow is the same as an existing one, except for a few differences. Sponsor/broker users can copy an existing workflow map that describes the acts to be executed. Once the workflow map has been copied, sponsor/brokers can make any desired changes to create a new workflow map. The copy function can be a practical tool for complex workflows that would have required considerable labor to recreate.

The present correspondence system 842, automates the process of generating a letter in response to a client or other business requirements. As shown, the present workflow system 810 is coupled to the accounts and record system 806 allowing relevant data to be transferred to the workflow system 810 for automated letter generation and other workflow functions. Through a workflow process, a sponsor/broker system 812 can select a complete form letter and have it automatically generated in its entirety, compose a letter by selecting relevant paragraphs, and manually compose a paragraph or insert information into a letter that is otherwise automatically addressed and generated. Other features of the present correspondence system 842 allow sponsor/brokers to manually compose an entire letter and also provide multiple output formats. Once a letter is composed and optionally quality checked through the present correspondence system 842, it is can be stored in a data warehouse to simplify reproduction and distribution. In addition, letter images can be stored through the present correspondence system 842 with any incoming customer documents, creating a complete history of a transaction or letter.

The invention is not limited to a particular technology. The present open platform account architecture preferably can integrate any legacy application or communication protocol and can be resident to one or more servers. One open platform comprises an open architecture that accommodates a variety of data formats, including, but not limited to, Microsoft® Excel which is available from Microsoft Corporation located at One Microsoft Way, Redmond Wa., USA or CSV files, for example.

Many other alternatives are also possible. For example, one embodiment comprises a HiInvest^{SM} Server coupled to an AWD/NetServer^{SM}, a MAP AWD Server, an ST Server, and a TA 2000 CICS region running on a large scale mainframe computer HiInvest^{SM} is available from DST International located at DST House, St. Mark's Hill, Surbiton, Surrey, United Kingdom. The AWD/NetServer^{SM}, MAP AWD Server, ST Server, and TA 2000 Server are available from DST Systems, Inc., located at 333 W. 11th Street Kansas City, Mo., USA.

The above described present embodiments provide decision support and trading functionality that provides sponsors, investment managers/firms, advisor/firms with tools to maximize investment returns and minimize costs. The seamless integration of workflow, portfolio management, and mutual fund recordkeeping systems and methods reduce overhead for sponsors, streamlines communications, provides sophisticated tools for investment management and advisors, provides accurate and efficient trading and reconciliation, and provides an industry wide utility.

While various embodiments of the invention have been described, it will be apparent to those of ordinary skill in the art that many more embodiments and implementations are possible and are within the scope of this invention. Accordingly, the invention is not to be restricted except in light of the attached claims and their equivalents.

What is claimed is:

1. An open platform, comprising:
a portfolio management system configured to provide multi-asset transaction processing;
a workflow system coupled to the portfolio management system configured to deliver and process work based on user-defined priorities; and;
a mutual fund recordkeeping system coupled to the portfolio management system and the workflow system.

2. The open platform of claim 1 wherein the portfolio management system is further configured to a provide portfolio accounting, a performance measurement, a reporting, and a trading.

3. The open platform of claim 1 wherein the portfolio management system comprises a decision support system that provides portfolio modeling analysis.

4. The open platform of claim 1 wherein the portfolio management system comprises a decision support system configured to filter an investment execution based on one of a broker type, an instrument type, and a transaction type.

5. The open platform of claim 1 wherein the portfolio management system comprises an order management system configured to manage an order from its placement to its execution.

6. The open platform of claim 6 wherein the order comprises an individual order.

7. The open platform of claim 6 wherein the order comprises an omnibus order.

8. The open platform of claim 1 wherein the portfolio management system comprises a compliance system that detects rule violations.

9. The open platform of claim 1 wherein the portfolio management system comprises: a decision support system that can provide portfolio modeling analysis and can filter an investment execution based on one of a broker type, an instrument type, and a transaction type; an order management system configured to manage an order from the order's placement to the order's execution; and a compliance system that detects rule violations.

10. The open platform of claim 1 wherein the workflow system comprises a facsimile system that can receive an inbound fax and can index and route the inbound fax through a workflow process using an identifier.

11. The open platform of claim 1 wherein the workflow system comprises a scanning system that can scan, capture, and archive a workflow object.

12. The open platform of claim 1 wherein the workflow system comprises a business rule engine that enables a user to generate a decision tree that can manage a workflow object.

13. The open platform of claim 1 wherein the workflow system comprises a graphical system that allows users to define workflow acts in a visual format.

14. The open platform of claim 1 wherein the workflow system comprises a correspondence system configured to automatically generate a correspondence.

15. The open platform of claim 1 wherein the workflow system comprises: a facsimile system that can receive an inbound fax and can index and route the inbound fax through a workflow process based on an identifier; a scanning system that can scan, capture, and archive a workflow object; a business rule engine that enables a user to generate a decision tree that can manage the workflow object; a graphical system that allows the user to define workflow acts in a visual format; and a correspondence system configured to automatically generate a correspondence.

16. The open platform of claim 9 wherein the workflow system comprises: a facsimile system that can receive an inbound fax and can index and route the inbound fax through a workflow process based on an identifier; a scanning system that can scan, capture, and archive a workflow object; a business rule engine that enables a user to generate a decision tree that can manage the workflow object; a graphical system that allows the user to define workflow acts in a visual format; and a correspondence system configured to automatically generate a correspondence.

17. The open platform of claim 1 further comprising a hub coupled to a sponsor system and a portfolio management system.

18. The open platform of claim 17 further comprising a sponsor and broker system and a custodial system coupled to the hub.

19. The open platform of claim 1 further comprising an accounting and records system coupled to the portfolio management system and the workflow system.

20. The open platform of claim 1 further comprising a reconciliation system coupled to the workflow system.

21. The open platform of claim 20 wherein the reconciliation system is configured to ensure accounts resident to a custodial system are in compliance with records resident to an accounting and records system, the accounting and records system being coupled to the portfolio management system.

22. The open platform of claim 1 further comprising a trading system coupled to the portfolio management system.

23. The open platform of claim 21 wherein the trading system comprises an automated matching system.

24. The open platform of claim 1 wherein the portfolio management system is resident to a first server and the workflow system is resident to a second server and the first and second servers present an appearance of a single server to a user.

25. An open platform that allows advisors and sponsors to select assets and styles based on a customer's objectives, comprising:
a portfolio management system;
a compliance system configured to review an object selected through the portfolio management system;
a trading system configured to execute orders received through the portfolio management system;
a reporting system configured to generate reports based on a user-defined request received through the portfolio management system;
a workflow system configured to deliver work flow objects based on a user-defined priority; and
a mutual fund recordkeeping system coupled to the portfolio management system and the workflow system to track a shareowner's position.

26. The open platform of claim 25 further comprising a billing system coupled to the portfolio management system that can debit transaction fees.

27. The open platform of claim 25 further comprising an electronic posting system coupled to the portfolio management system that provides client confidential information over a secure electronic mail system.

28. The open platform of claim 25 further comprising a performance measurement system coupled to the portfolio management system configured to measure investment performance returns.

29. The open platform of claim 25 further comprising a data warehouse coupled to the portfolio management system and the workflow system, the data warehouse being configured to store and retrieve all user information.

30. A method of processing an open platform account, comprising:
receiving customer information;
automatically sending the customer information to a site for approval; and
automatically checking that information to ensure the information satisfies a compliance criterion; and
recording a mutual fund transaction in a mutual fund recordkeeping system.

31. The method of processing an open platform account further comprising storing the information in a data warehouse.

32. The method of processing an open platform account wherein the act of receiving the customer information comprising receiving the customer information through a portfolio management system and storing the information in an accounting and records system coupled to a workflow system.

33. The method of processing an open platform account wherein site comprises a publicly accessible site.
